(19) United States
(12) Patent Application Publication
(10) Pub. No.: US 2019/0379807 A1
(43) Pub. Date: Dec. 12, 2019

(54) IMAGE PROCESSING DEVICE, IMAGE PROCESSING METHOD, IMAGING APPARATUS, AND PROGRAM

(71) Applicant: Sony Corporation, Tokyo (JP)

(72) Inventor: Akira Tokuse, Tokyo (JP)

(21) Appl. No.: 16/077,186

(22) PCT Filed: Jan. 19, 2017
(86) PCT No.: PCT/JP2017/001693

§ 371 Date: Aug. 10, 2018

(30) Foreign Application Priority Data
Mar. 9, 2016 (JP) 2016-045504

(51) Int. Cl. H04N 5/225; G02B 5/30; G02F 1/1337; G02B 27/46; G03B 11/00

(52) U.S. Cl. CPC H04N 5/2254; G02B 5/3083; G03B 11/00; G02B 27/46; G02F 1/133753

(57) ABSTRACT

An image processing device of the present disclosure includes an image processor that generates image data on the basis of a plurality of pieces of raw image data shot with mutually different lowpass characteristics of an optical lowpass filter, the image data that is higher in resolution than each of the plurality of pieces of raw image data.

### TECHNICAL FIELD

The present disclosure relates to an image processing device and an image processing method, an imaging apparatus, and a program that are associated with processing of image data shot with use of an optical lowpass filter.

### BACKGROUND ART

A typically well-known single-plate digital camera perform shooting through Bayer coding in converting light into an electrical signal, and performs demosaicing processing on RAW data obtained by the shooting to restore information of lost pixel values.

### CITATION LIST

### Patent Literature

PTL 1: Japanese Unexamined Patent Application Publication No. 2008-271060

### SUMMARY OF THE INVENTION

However, true values of the pixel values are not obtainable by typical demosaicing processing, which makes it difficult to avoid degradation in resolution and occurrence of an artifact. A three-plate camera is available as a camera that allows for avoidance of such issues; however, the three-plate camera has a disadvantage of an increase in size of an imaging system, and poor portability. Further, it is also considered to improve resolution by shooting a plurality of images using an image stabilizer to synthesize the plurality of images. However, in such a case, a mechanical mechanism is necessary; therefore, high mechanical accuracy may be necessary.

Further, there is proposed a method in which light incoming through a slit is separated with use of a lowpass filter, and thereafter, information of pixels is restored. However, this is a technique for a line sensor, and it is difficult to apply the method to a two-dimensional imager.

It is desirable to provide an image processing device, an image processing method, an imaging apparatus, and a program that allow a high-resolution image to be obtained.

An image processing device according to an embodiment of the present disclosure includes an image processor that generates image data on the basis of a plurality of pieces of raw image data shot with mutually different lowpass characteristics of an optical lowpass filter, the image data that is higher in resolution than each of the plurality of pieces of raw image data.

An image processing method according to an embodiment of the present disclosure includes: generating image data on the basis of a plurality of pieces of raw image data shot with mutually different lowpass characteristics of an optical lowpass filter, the image data that is higher in resolution than each of the plurality of pieces of raw image data.

An imaging apparatus according to an embodiment of the present disclosure includes: an image sensor; an optical lowpass filter disposed on a light entrance side with respect to the image sensor; and an image processor at generates image data on the basis of a plurality of pieces of raw image data shot with mutually different lowpass characteristics of the optical lowpass filter, the image data that is higher in resolution than each of the plurality of pieces of raw image data.

A program according to an embodiment of the present disclosure causes a computer to serve as an image processor that generates image data on the basis of a plurality of pieces of raw image data shot with mutually different lowpass characteristics of an optical lowpass filter, the image data that is higher in resolution than each of the plurality of pieces of raw image data.

In the image processing device, the image processing method, the imaging apparatus, or the program according to the embodiment of the present disclosure, on the basis of the plurality of pieces of raw image data shot with mutually different lowpass characteristics of an optical lowpass filter, the image data is higher in resolution than each of the plurality of pieces o t raw image data is generated.

According to the image processing device, the image processing method, the imaging apparatus, or the program of the embodiment of the present disclosure, on the basis of the plurality of pieces of raw image data shot with mutually different lowpass characteristics of an optical lowpass filter, the image data is higher in resolution than each of the plurality of pieces of raw image data is generated, which makes it possible to obtain a high-resolution image.

It is to be noted that effects described here are not necessarily limited and may include any of effects described in the present disclosure.

### BRIEF DESCRIPTION OF DRAWINGS

FIG. 1 is a configuration diagram illustrating a basic configuration example of an imaging apparatus according to a first embodiment of the present disclosure.

FIG. 2 is an explanatory diagram illustrating an example of a Bayer pattern.

FIG. 3 is a cross-sectional view of a configuration example of a variable optical lowpass filter.

FIG. 4 is an explanatory diagram illustrating an example of a state in which a lowpass effect in the variable optical lowpass filter illustrated in FIG. 3 is 0% (filter off).

FIG. 5 is an explanatory diagram illustrating an example of a state in which the lowpass effect in the variable optical lowpass filter illustrated in FIG. 3 is 100% (filter on).

FIG. 6 is a flowchart illustrating an overview of operation of the imaging apparatus according to the first embodiment.

FIG. 7 is a flowchart illustrating an overview of operation of a typical image processor.

FIG. 8 is an explanatory diagram illustrating an overview of image processing performed by the imaging apparatus according to the first embodiment.

FIG. 9 is an explanatory diagram illustrating an example of a state in which light enters each pixel in a case where shooting is performed with a lowpass filter turned on.

FIG. 10 is an explanatory diagram illustrating an example of a light entering state in focusing attention on one pixel in a case where shooting is performed with the lowpass filter turned on.

FIG. 11 is an explanatory diagram illustrating an example of coefficients determined by a degree of separation of the lowpass filter.

FIG. 12 is a flowchart illustrating an overview of operation of an imaging apparatus according to a second embodiment.

FIG. 13 is an explanatory diagram illustrating an overview of image processing performed by the imaging apparatus according to the second embodiment.

FIG. 14 is a configuration diagram illustrating an example of a pixel structure including infrared pixels.

FIG. 15 is a configuration diagram illustrating an example of the pixel structure including pixels each having a phase difference detection function.

FIG. 16 is a configuration diagram illustrating an example of the pixel structure including phase difference pixels.

### MODES FOR CARRYING OUT THE INVENTION

Hereinafter, embodiments of the present disclosure are described in detail with reference to the drawings. It is to be noted that description is given in the following order.

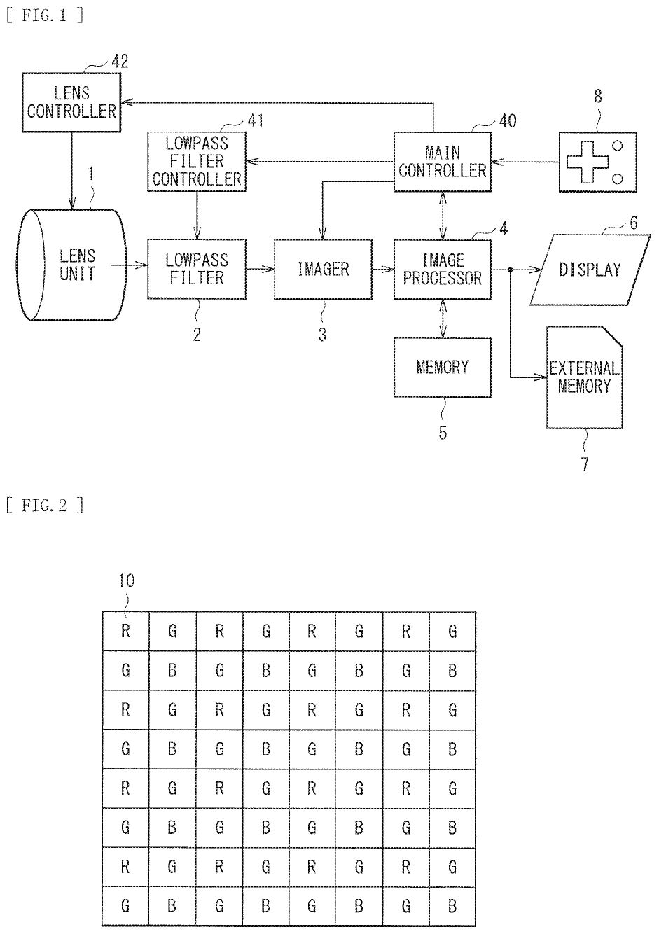

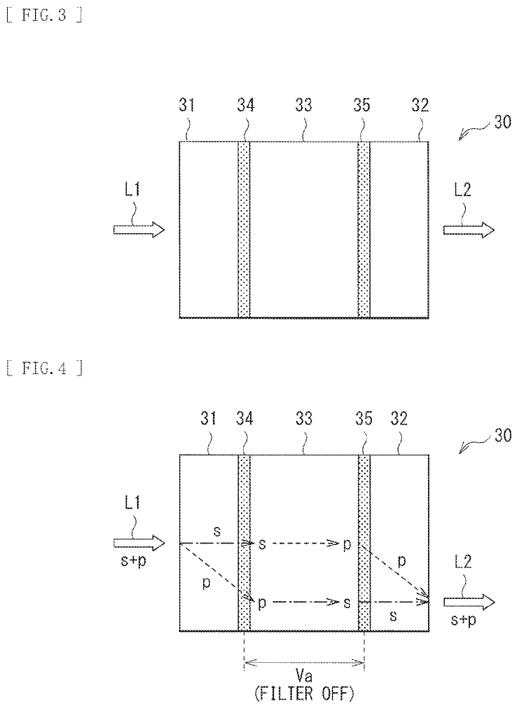

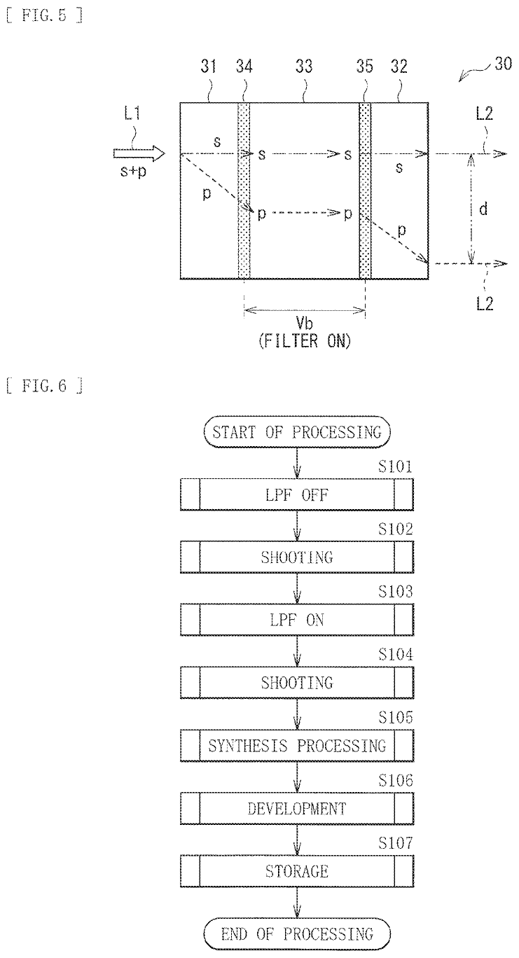

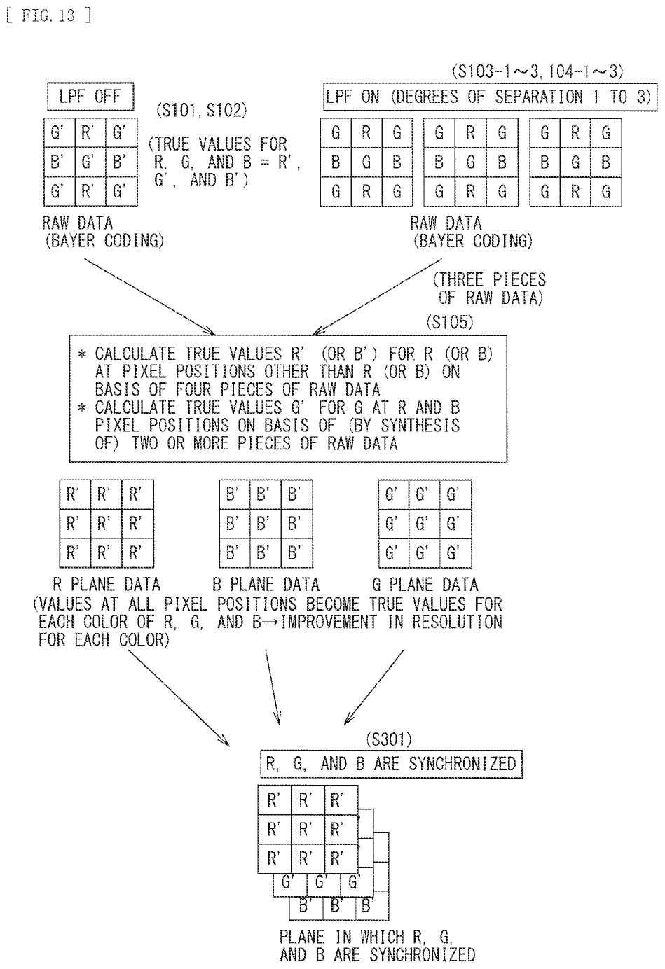

1. First Embodiment (image processing with use of two pieces of raw image data)
1.1 Overview of Imaging Apparatus (FIG. 1 and FIG. 2)
1.2 Configuration and Principle of Variable Optical Lowpass Filter (FIGS. 3 to 5)
1.3 Operation of Imaging Apparatus and Specific Examples of linage Processing (FIG. 6 to FIG. 11)
1.4 Effects
   2. Second Embodiment (image processing with use of four pieces of raw image data) (FIG. 12 and FIG. 13)

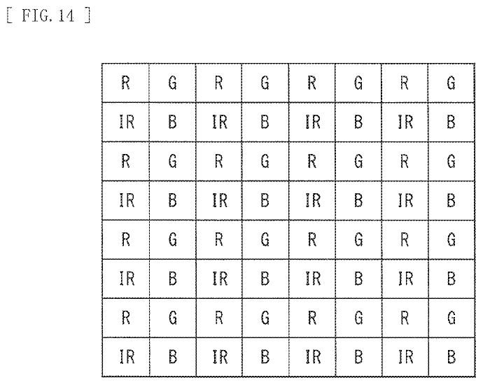

### 3. Other Embodiments (FIGS. 14 to 16)

### 1. First Embodiment

### 1.1 Overview of Imaging Apparatus

FIG. 1 illustrates a basic configuration example of an imaging apparatus according to a first embodiment of the present disclosure.

The imaging apparatus according to the present embodiment includes a lens unit 1, a lowpass filter (LPF) 2, an imager (an image sensor) 3, an image processor 4, a memory 5, a display 6, an external memory 7, an operation unit 8, a main controller 40, a lowpass filter controller 41, and a lens controller 42.

As the lowpass filter 2, it is possible to use a variable optical lowpass filter 30 of which lowpass characteristics are varied by controlling a degree of separation of light for incoming light L1, as illustrated in FIG. 3 to FIG. 5 to be described later.

In the imaging apparatus, light is captured from the lens unit 1, and an image from which the light is separated by the lowpass filter 2 is formed on the imager 3. The imager 3 performs photoelectric conversion and A/D (Analog-to-Digital) conversion of an optical image, and transfers raw image data (RAW data) to the image processor 4.

The image processor 4 performs development processing while using the memory 5, and displays a shooting result on the display 6. Further, the image processor 4 stores the shooting result in the external memory 7. Each of the image processor 4 and the main controller 40 incorporates a CPU (Central Processing Unit) that configures a computer.

The main controller 40 receives an instruction from the operation unit 8, and controls the lens unit 1 through the lens controller 42. Further, the main controller 40 controls a degree of separation of the lowpass filter 2 through the lowpass filter controller 41.

Pixels 10 of the imager 3 typically have a coding pattern called a Bayer pattern as illustrated in FIG. 2. The pixels 10 of the imager 3 include pixels of three colors of R (red), G (green), and B (blue) that are arrayed two-dimensionally, and are different from one another in positions for each color, as illustrated in FIG. 2. Each of the pixels 10 of the imager 3 is able to acquire only a value of an element including one of R, G, and B. Therefore, in a case where the image processor 4 performs the development processing, processing called demosaicing is carried out to infer information that is unable to be acquired from values of peripheral pixels and perform planation. However, typical demosaicing processing is only inference processing, by which it is not possible to know a true value in principle, As a result, degradation in the resolution and artifacts such as moiré and false coloring appear in a final image. For example, in case of the Bayer pattern as illustrated in FIG. 2, if the total number of pixels is X, the number of G pixels is X/2. Further, the number of pixels other than the G pixels is X/2 (the number of R pixels is X/4, and the number of B pixels is X/4). Moreover, in a case where shooting is performed with the lowpass filter 2 turned off, correct pixel values for G are obtained directly at positions of the number X/2 of G pixels. In contrast, it is not possible to obtain correct pixel values for G directly at positions of the pixels other than the number X/2 of G pixels; therefore, the demosaicing processing is necessary as described above. In the present embodiment, a correct pixel value at a given pixel position is called a “true value”. For example, as described above, the pixel values for G at the positions of the number X/2 of G pixels that are obtained in a case where shooting is performed with the lowpass filter 2 turned off are true values for G.

Therefore, in the technology of the present disclosure, a plurality of pieces of raw image data shot with mutually different lowpass characteristics of the lowpass filter 2 are synthesized to generate image data that is higher in resolution than each of the plurality of pieces of raw image data. The image processor 4 calculates a pixel value of at least one predetermined color of a plurality of colors at a position different from positions of pixels of the predetermined color. The “pixel value at the position different from the positions of the pixels of the predetermined color” here refers to a pixel value of the predetermined color (for example, G) at a position different from positions where the pixels of the predetermined color are present in the imager 3, for example. Alternatively, the “pixel value at the position different from the positions of the pixels of the predetermined color” also refers to a pixel value of the predetermined color for example, G) at a position different from positions where the pixels of the predetermined color are present in the raw image in a case where the shooting is performed with the lowpass filter 2 turned off.

Here, in the present embodiment, “high-resolution image data” refers to image data having more true values or values close to true values than raw image data. For example, as described above, in a case of the Bayer pattern as illustrated in FIG. 2, in raw image data obtained by shooting with the lowpass filter 2 turned off, the true values for G are obtained in the number X/2 of pixels. In contrast, calculation of the true values for G in pixels other than the number X/2 of pixels makes it possible to obtain image data that is higher in resolution for G than raw image data. In such a case, even if the image data is not improved in resolution for other colors (R and B) more than the raw image data, “average resolution” or “resolving efficiency” in total of R, G, and B is improved more than that of the raw image data. The “raw image data” here refers to image data prior to generation (synthesis) of the high-resolution image data, and is not necessarily limited to RAW data itself that is outputted from the imager 3.

In the present embodiment, the plurality of pieces of raw image data to be synthesized include two pieces of raw image data. The image processor 4 calculates a true value of one predetermined color of the three colors R, G, and B in a pixel at a position different from positions of pixels of the predetermined color. This makes it possible to calculate a true value of the predetermined color at a position of a pixel of a color other than the predetermined color, for example. More specifically, as the two pieces of raw image data, two kinds of raw image data including an image shot with the lowpass filter 2 turned off and an image shot with the lowpass filter 2 turned on are obtained. A higher-resolution and artifact-free image is obtained by using information obtained from these raw image data.

### 1.2 Configuration and Principle of Variable Optical Lowpass Filter

As the lowpass filter 2, it is possible to use a liquid crystal optical lowpass filter (the variable optical lowpass filter 30) as illustrated in FIG. 3 to FIG. 5, for example.

### Configuration Example of Variable Optical Lowpass Filter 30

FIG. 3 illustrates a configuration example of the variable optical lowpass filter 30. The variable optical lowpass filter 30 includes a first birefringent plate 31 and a second birefringent plate 32, a liquid crystal layer 33, and a first electrode 34 and a second electrode 35. The variable optical lowpass filter 30 adopts a configuration in which the liquid crystal layer 33 is interposed between the first electrode 34 and the second electrode 35, and is further interposed between the first birefringent plate 31 and the second birefringent plate 32 from the outside thereof. The first electrode 34 and the second electrode 35 apply an electrical field to the liquid crystal layer 33. It is to be noted that the variable optical lowpass filter 30 may further include an alignment film that controls alignment of the liquid crystal layer 33, for example. Each of the first electrode 34 and the second electrode 35 includes one transparent sheet-like electrode. It is to be noted that at least one of the first electrode 34 and the second electrode 35 may include a plurality of partial electrodes.

The first birefringent plate 31 is disposed on a light incoming side of the variable optical lowpass filter 30, and, for example, an outer surface of the first birefringent plate 31 serves as a light incoming surface. The incoming light L1 is light that enters the light incoming surface from a subject side. The second birefringent plate 32 is disposed on a light outgoing side of the variable optical lowpass filter 30, and, for example, an outer surface of the second birefringent plate 32 serves as a light outgoing surface. Transmitted light L2 of the variable optical lowpass filter 30 is light that is outputted from the light outgoing surface to outside.

Each of the first birefringent plate 31 and the second birefringent plate 32 has birefringent property, and has a uniaxial crystal structure. Each of the first birefringent plate 31 and the second birefringent plate 32 has a function of performing ps separation of circularly-polarized light utilizing the birefringent property. Each of the first birefringent plate 31 and the second birefringent plate 32 includes, for example, crystal, calcite, or lithium niobate.

The liquid crystal layer 33 includes, for example, a TN (Twisted Nematic) liquid crystal. The TN liquid crystal has optical rotation property that rotates a polarization direction of passing light along rotation of the nematic liquid crystal.

A basic configuration in FIG. 3 makes it possible to control lowpass characteristics in a specific one-dimensional direction. Use of a plurality of variable optical lowpass filters 30 allows the incoming light L1 to be separated in a plurality of directions. For example, use of two sets of the variable optical lowpass filters 30 makes it possible to separate the incoming light L1 into a horizontal direction and a vertical direction, thereby controlling the lowpass characteristics two-dimensionally.

### Principle of Variable Optical Lowpass Filter 30

The principle of the variable optical lowpass filter 30 is described with reference to FIG. 4 and FIG. 5. FIG. 4 illustrates an example of a state in which a lowpass effect in the variable optical lowpass filter illustrated in FIG. 3 is 0% (filter off, and a degree of separation is zero). FIG. 5 illustrates an example of a state in which the lowpass effect is 100% (filter on). It is to be noted that each of FIG. 4 and FIG. 5 exemplifies a case where an optical axis of the first birefringent plate 31 and an optical axis of the second birefringent plate 32 are parallel to each other.

The variable optical lowpass filter 30 is allowed to control a polarization state of light, and to vary the lowpass characteristics continuously. In the variable optical lowpass filter 30, the lowpass characteristics is controllable by changing an electrical field to be applied to the liquid crystal layer 33 (a voltage to be applied across the first electrode 34 and the second electrode 35). For example, as illustrated in FIG. 4, the lowpass effect becomes (same as a case where no filtering is provided) in a state in which the applied voltage is Va (tor example, 0 V). Further, as illustrated in FIG. 5, the lowpass effect becomes maximum (100%) in a state in which an applied voltage Vb that is different from the Va is applied.

The variable optical lowpass filter 30 allows the lowpass effect to be put in an intermediate state by changing the applied voltage Vb between the voltage Va and the voltage Vb. The characteristics to be achieved in a case where the lowpass effect becomes maximum are determined by characteristics of the first birefringent plate 31 and the second birefringent plate 32.

In each of the states in FIG. 4 and FIG. 5, the first birefringent plate 31 separates the incoming light L1 into an s-polarized component and a p-polarized component.

In the state illustrated in FIG. 4, optical rotation becomes 90 degrees in the liquid crystal layer 33, which causes the s-polarized component and the p-polarized component to be respectively converted into a p-polarized component and an s-polarized component in the liquid crystal layer 33. Thereafter, the second birefringent plate 32 synthesizes the p-polarized component and the s-polarized component into the transmitted light L2. In the state illustrated in FIG. 4, a final separation width d between the s-polarized component and the p-polarized component is zero, causing the lowpass effect to become zero.

In the state illustrated in FIG. 5, optical rotation becomes 0 degrees in the liquid crystal layer 33, which causes the s-polarized component and the p-polarized component to respectively pass through the liquid crystal layer 33 as the s-polarized component and as the p-polarized component. Thereafter, the second birefringent plate 32 further expands the separation width between the s-polarized component and the p-polarized component. In the state illustrated in FIG. 5, in the final transmitted light L2, the separation width d between the s-polarized component and the p-polarized component becomes a maximum value dmax, causing the lowpass effect to become maximum (100%).

In the variable optical lowpass filter 30, the lowpass characteristics are controllable by changing the applied voltage Vb to control the separation width d. A magnitude of the separation width d corresponds to a degree of separation of light by the variable optical lowpass filter 30. In the present embodiment, the “lowpass characteristics” refer to the separation width d, or the degree of separation of light. As described above, the variable optical lowpass filter 30 allows the lowpass effect to be put in an intermediate state between 0% and 100% by changing the applied voltage Vb between the voltage Va and the voltage Vb. In such a case, the optical rotation in the liquid crystal layer 33 may become an angle between 0 degree and 90 degrees in the intermediate state. Further, the separation width d in the intermediate state may become smaller than the value dmax of the separation width d, in a case where the lowpass effect is 100%. A value of the separation width d in the intermediate state may take any value between 0 and the value dmax by changing the applied voltage Vb. Here, the value of the separation width d may be set to an optimum value corresponding to a pixel pitch of the imager 3. The optimum value of the separation width d may be, for example, a value that allows a light beam entering a specific pixel in a case where the lowpass effect is 0% to be separated to enter another pixel adjacent to the specific pixel in a vertical direction, a horizontal direction, a left oblique direction, or a right oblique direction.

### 1.3 Operation of Imaging Apparatus and Specific Examples of Image Processing

FIG. 6 represents an overview of operation of the imaging apparatus according to the present embodiment. First, the imaging apparatus puts the lowpass filter 2 in an off state (step S101) to perform shooting (step S102). Next, the imaging apparatus puts the lowpass filter 2 in an on state (step S103) to perform shooting again (step S104). Thereafter, the imaging apparatus performs, in the image processor 4, synthesis processing on two kinds of raw image data including an image shot with the lowpass filter turned off and an image shot with the lowpass filter on (step S105). Subsequently, the imaging apparatus performs development of a synthesized image (step S106) to store the synthesized image in the external memory 7 (step S107).

The image processor 4 converts raw image data (RAW data) outputted from the imager 3 into JPEG (Joint Photographic Experts Group) data, for example.

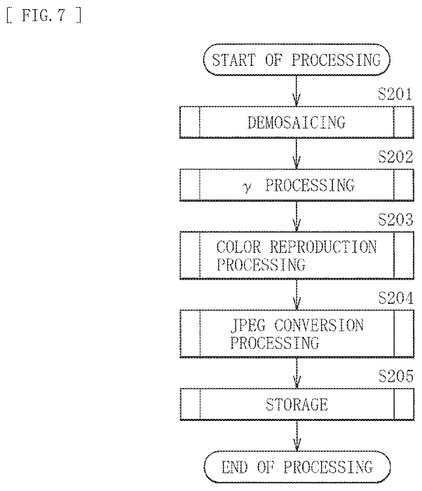

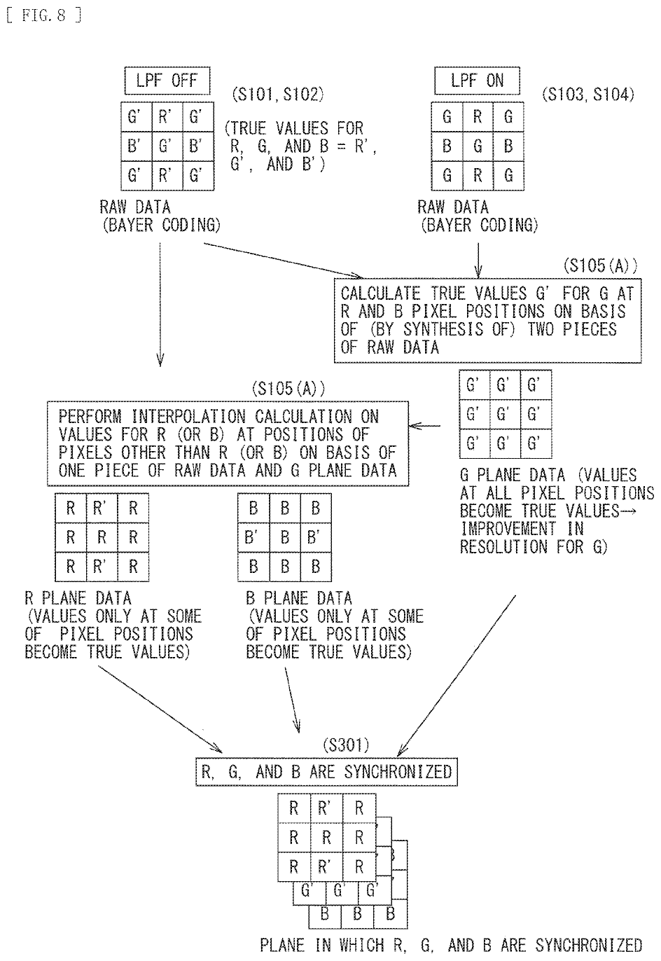

FIG. 7 illustrates an overview of operation of the typical image processor 4. First, the image processor 4 performs demosaicing processing on the RAW data (step S201). In the demosaicing processing, interpolation processing is executed on Bayer-coded RAW data to generate a plane where R, G and B are synchronized.

Next, the image processor 4 carries out γ processing (step S202) and color reproduction processing (step S203) on data of the RGB plane. In the γ processing and the color reproduction processing, a γ curve and a matrix for color reproduction corresponding to spectroscopic characteristics of the imager 3 are applied to the data of the RGB plane, and RGB values are converted into a standard color space such as Rec. 709, for example.

Thereafter, the image processor 4 performs JPEG conversion processing on the data of the RGB plane (step S204). In the JPEG conversion processing, the RGB plane is converted into a YCbCr color space for transmission, and a Cb/Cr component is thinned out to a half in a horizontal direction, and thereafter JPEG compression is performed.

Next, the image processor 4 carries out storage processing (step S205). In the storage processing, a suitable JPEG header is assigned to the JPEG data, and the data is stored as a file in the external memory 7 or the like.

The technology by the present disclosure replaces a portion of the demosaicing processing in the step S201 in essence in the typical processing illustrated in FIG. 7 with new image processing. A concept of the new image processing as an alternative to the typical demosaicing processing is schematically illustrated in FIG. 8. FIG. 8 schematically illustrates a concept of the image processing corresponding to the processing including the steps S101 to S105 in FIG. 6. In the typical demosaicing processing, one piece of Bayer-coded RAW data is inputted as raw image data. In the present embodiment, as illustrated in steps S101 and S102, and steps S103 and S104 in FIG. 8, two pieces of the Bayer-coded RAW data are inputted as raw image data. In a second embodiment to be described later, four pieces of the Bayer-coded RAW data are inputted as raw image data.

It is to be noted that, even in a case where the technology by the present disclosure is used, as illustrated in steps S105(A) and S105(B) in FIG. 8, plane data of each of R, G and B is generated like the typical demosaicing processing, and plane data in which R, G, and B are synchronized is finally outputted as illustrated in step S301 in FIG. 8. In such a case, in generating G plane data, true values G′ for G at positions of R and B pixels are calculated on the basis of (by synthesis of) two pieces of RAW data. Therefore, in the G plane data, values at all the pixel positions become the true values, resulting in improved resolution for G. This makes it possible to output an image having higher resolution and fewer artifacts than an image obtained by existing demosaicing processing.

As the new image processing, the present embodiment describes the processing of calculating true values of a specific color of the three colors of R, G, and B in the pixels at all the pixel positions. Hereinafter, as an example, description is provided on a case where a pixel array of raw image data is the Bayer pattern as illustrated in FIG. 2. In the following description, the “G pixel” refers to a G pixel in the raw image data. Similarly, the “R pixel” and the “B pixel” refer to an R pixel and a B pixel in the raw image data, respectively. Further, the “number of G pixels” refers to the number of G pixels in the raw image data. Similarly, the “number of R pixels” and the “number of B pixels” refer to the number of R pixels and the number of B pixels in the raw image data, respectively.

As described above, in the case of the Bayer pattern as illustrated in FIG. 2, if the total number of the pixels is X, the number of the G pixels is X/2. Therefore, in a case where shooting is performed with the lowpass filter 2 turned off, the true values G′ of the pixel values for G are obtained at positions of the number X/2 of the G pixels, as illustrated in the steps S101 and S102 in FIG. 8. Further, the number of pixels other than the G pixels is X/2. At positions of the number X/4 of pixels of the number X/2 of pixels other than the G pixels, true values R′ of the pixel values for G are obtained. At positions of the remaining number X/4 of pixels, true values B′ of the pixel values of B are obtained. Consequently, if shooting is performed with the lowpass filter 2 turned off, the number of pixels in which the true values G′ of the pixel values for G are not obtainable is X/2. It is possible to represent G′_{xy} by the following (Expression 1), where a true value of the G pixel at a given pixel position xy is G′_{xy}, and a value of a G pixel at the pixel position xy in a case where shooting is performed with the lowpass filter 2 turned off is G_{xy}.

G′_{xy} =G_{xy} (Expression 1)

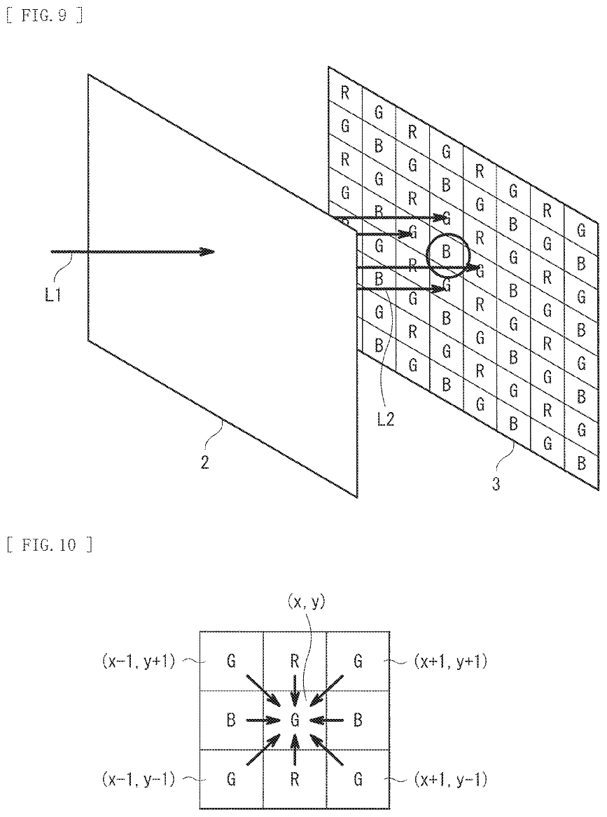

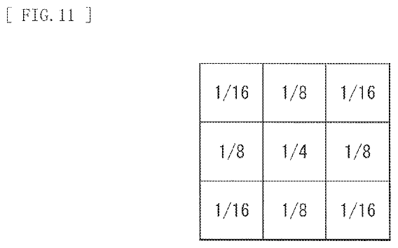

FIG. 9 illustrates an example of a state in which light enters each pixel in a case where shooting is performed with a lowpass filter 2 turned on. FIG. 10 illustrates an example of a light entering state in focusing attention on one pixel in a case where shooting is performed with the lowpass filter 2 turned on.

In terms of pixel positions other than the G pixel positions, upon shooting with the lowpass filter 2 turned on, light of G that has entered a B pixel position encircled as illustrated in FIG. 9 is separated by the lowpass filter 2 to flow into peripheral G pixel positions. In other words, with attention focused on a given G pixel, in a case where shooting is performed with the lowpass filter 2 turned on, while the lowpass filter is turned off, the light of G that has entered peripheral pixel positions flows into the given G pixel, as illustrated in FIG. 10.

At this time, it is possible to represent GL_{xy} at the G pixel position by the following (Expression 2), where a value in a case where shooting is performed with the lowpass filter 2 turned on is GL_{xy}.

GL_{xy}=αG′_{xy}+βG′_{x-1y}+βG′_{x+1y}+βG′_{xy-1}+βG′_{xy+1}+γG′_{x-1y-1}+γG′_{x-1y+1}+γG′_{x+1y-1}+γG′_{x+1y+1} (Expression 2)

Here, each of G′_{x-1y}, G′_{xy+1y}, G′_{xy-1}, and G′_{xy+1} means a true value for G at the R pixel position and the B pixel position on the top, bottom, left, or right of GL_{xy} at the G pixel position, and is unknown quantity at the present moment.

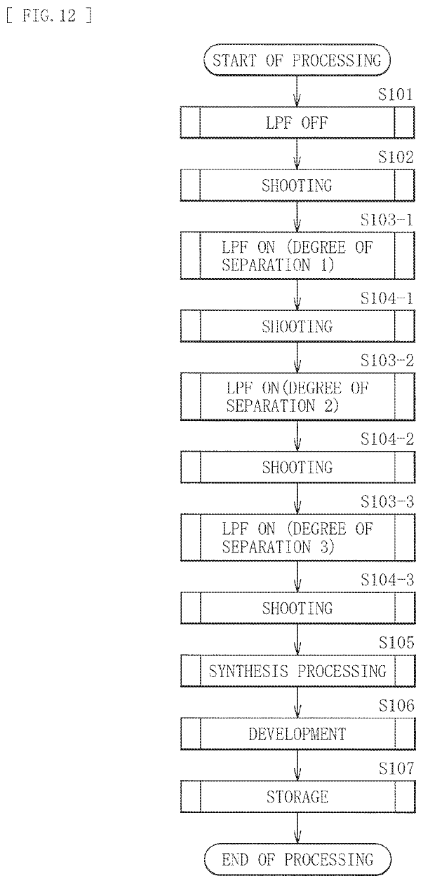

α, β, and γ are coefficients determined by a degree of separation of the lowpass filter 2, and are known values that are controlled by the image processor 4, and are determined by the characteristics of the lowpass filter 2. FIG. 11 represents an example of the coefficients α, β, and β. For example, −α=0.25, β=0.125, and γ=0.0625 are specified.

G′_{xy} is the value G_{xy} obtained in a case where shooting is performed with the lowpass filter 2 turned off according to the (Expression 1). Further, the values G′_{x-1y-1}, G′_{x-1y+1}, G′_{x+1y -1}, and G′_{x+1y+1} are true values for G at the G pixel positions; therefore, it is possible to replace each of these values with a value obtained in a case where shooting is performed with the lowpass filter 2 turned off.

Accordingly, for the G pixel positions, it is possible to represent the (Expression 2) by the following (Expression 3).

GL_{xy}=αG_{xy}+βG′_{x-1y}+βG′_{x+1y}+βG′_{xy-1}+βG′_{xy+1}+γG_{x-1y-1}+γG_{x-1y+1}+γG_{x+1y-1}+γG_{x+1y+1} (Expression 3)

On a view of a whole image, it is possible to establish the (Expressions 3) equal in number to the G pixels at respective positions, and the number of unknown quantities becomes equal to the number of R pixel positions and B pixel positions, resulting in matching between the number of expressions and the number of unknown quantities. Therefore, solving a series of simultaneous equations to be obtained from the whole image makes it possible to determine all of the unknown quantities. Here, the unknown quantities refer to true values for G at the R pixel positions or the B pixel positions. Consequently, using data of two images including an image shot with the lowpass filter 2 turned on and an image shot with the lowpass filter 2 turned off as the raw image data makes it possible to know the true values for G at all of the pixel positions.

As described above, in the present embodiment, in the image processor 4, it is possible to calculate true values for one color (G) of the three colors R, G, and B of the pixel at all the pixel positions. However, it is not possible to calculate true values for the other two colors (R and B) at all the pixel positions.

As described above, in the case of the Bayer pattern as illustrated in FIG. 2, if the total number of pixels is X, the number of G pixels is X/2, and the number of unknown pixels for the G pixels is X/2. In contrast, the number of the R pixels is X/4, and the number of unknown pixels for the R pixels is 3X/4. Similarly, the number of the B pixels is X/4, and the number of unknown pixels for the B pixels is 3X/4. Thus, in the case of the Bayer pattern, each of the number of R pixels and the number of B pixels is smaller than the number of G pixels; therefore, it is not possible to establish a sufficient number of expressions to obtain true values for R and B at all the pixel positions in a case where two images are shot. However, many of components of a luminance signal that is important in image resolution depend on the values for G; therefore, only calculation of the true values for G at all the pixel positions makes it possible to obtain a sufficiently high-definition image, as compared with existing technology.

It is to be noted that in a technique according to the present embodiment, it is not possible to calculate true values at all the pixel positions upon generation of R plane data and B plane data; however, it is possible to infer the values at all the pixel positions through interpolation. For example, as illustrated in the step S105(B) in FIG. 8, on the basis of one piece of RAW data shot with the lowpass filter 2 turned off, and the G plane data determined as described above, it is possible to determine values for R (or B) at positions of pixels other than R (or B) through interpolation calculation. In such a case, values only at some of the pixel positions in the R plane data and the B plane data become true values R′ and B′, respectively. For example, for the values for R, the true value G′ determined upon generation of the G plane data is used to determine R-G′, and G′ is added back after linear interpolation of R-G′. In such a manner, frequency characteristics of G are reflected, which makes it possible to calculate the values having higher resolution for R as compared with existing technology. The same is true for the values for B.

### 1.4 Effects

As described above, according to the present embodiment, the image data that is higher in resolution than each of a plurality of pieces of raw image data is generated on the basis of two pieces of raw image data shot with mutually different lowpass characteristics of the lowpass filter 2, which makes it possible to obtain a high-resolution and high-definition image.

According to the present embodiment, it is possible to obtain shot images with higher resolution and fewer artifacts for a currently-available single-plate digital camera. Further, according to the present embodiment, it is possible to configure an imaging system in a smaller size as compared with a three-plate digital camera. Moreover, according to the present embodiment, a mechanical mechanism is unnecessary, which facilitates to secure control accuracy, as compared with a system using an image stabilizer.

It is to be noted that, in the above description, the true values for G of the number X/2 of unknown pixels are determined on the basis of two pieces of raw image data, which makes it possible to properly restore the pixel values for G at positions that are not determined essentially in the Bayer pattern. Meanwhile, using three pieces of raw image data with different lowpass characteristics of the lowpass filter 2 makes it possible to obtain the true values for G pixels of the number X/2 or more of unknown pixels. Specifically, it is possible to obtain the true values for G at virtual pixel positions that are present midway between actual pixel positions in the Bayer pattern. This makes it possible to further improve resolution.

It is to be noted that the effects described in the description are merely illustrative and non-limiting, and other effects may be included. This applies to effects achieved by the following other embodiments.

### 2. Second Embodiment

Next, description is provided on a second embodiment of the present disclosure. In the following, portions having configurations and workings that are substantially similar to those in the above-described first embodiment are not described as appropriate.

In the above-described first embodiment, description is provided on the processing with use of data of two images in total including one image shot with the lowpass filter 2 turned off, and one image shot with the lowpass filter 2 turned on as raw image data; however, the number of the images to be used is not limited to two. An increase in the number of the images makes it possible to obtain a higher-resolution image.

For example, in a case where one image shot with the lowpass filter 2 turned off, and three images having different degrees of separation shot with the lowpass filter 2 turned on, that is, four images in total are shot, it is possible to establish a sufficient number of expressions for unknown quantities for R and B as well.

FIG. 12 illustrates an overview of operation of an imaging apparatus according to the present embodiment. First, the imaging apparatus puts the lowpass filter 2 in the off state (step S101) to perform shooting (step S102). Next, the imaging apparatus puts the lowpass filter 2 in an on state with a degree of separation 1 (step S103-1) to perform shooting (step S104-1). Thereafter, the imaging apparatus puts the lowpass filter 2 in an on state with a degree of separation 2 (step S103-2) to perform shooting (step S104-2). Next, the imaging apparatus puts the lowpass filter 2 in an on state with a degree of separation 3 (step S103-3) to perform shooting (step S104-3). Here, the degree of separation 1, the degree of separation 2, and the degree of separation 3 have values that are different from one another. Thereafter, the imaging apparatus performs, in the image processor 4, synthesis processing on four kinds of raw image data in total including an image shot with the lowpass filter 2 turned off and three images having different degrees of separation that are shot with the lowpass filter 2 turned on (step S105). Subsequently, the imaging apparatus performs development of a synthesized image (step S106) to store the synthesized image in the external memory 7 (step S107).

The technology by the present disclosure replaces a portion of the demosaicing processing in the step S201 in essence in the typical processing illustrated in FIG. 7 with new image processing. A concept of the new image processing as an alternative to the typical demosaicing processing is schematically illustrated in FIG. 13. FIG. 13 schematically illustrates a concept of the image processing corresponding to the processing including the steps S101 to S105 in FIG. 12. In the typical demosaicing processing, one piece of Bayer-coded RAW data is inputted as raw image data. In the present embodiment, as illustrated in steps S101 and S102, and steps S103-1 to 3 and S104-1 to 3 in FIG. 13, four pieces of the Bayer-coded RAW data are inputted as raw image data.

Even in a case where the technology by the present disclosure is used, as illustrated in step S105 in FIG. 13, plane data of each of R, G, and B is generated like the typical demosaicing processing, and plane data in which R, G, and B are synchronized is finally outputted as illustrated in step S301 in FIG. 13. In such a case, in generating the G plane data, true values G′ for G at positions of R and B pixels are calculated on the basis of (by synthesis of) two or more pieces of RAW data. Therefore, in the G plane data, values at all the pixel positions become the true values, resulting in improved resolution for G. Further, in generating the R (or B) plane data, true values R′ (or B′) for R (or B) at positions of pixels other than R (or B) are calculated on the basis of (by synthesis of) four pieces of RAW data. Therefore, even in the R plane data and the B plane data, values at all the pixel positions become true values, resulting in the improved resolution for R and B as well.

In such a manner, in the present embodiment, the plurality of pieces of raw image data to be synthesized include four pieces of raw image data. It is possible for the image processor 4 to calculate the true values R′ for R at positions different from the R pixel positions, the true values G′ for G at positions different from the G pixel position, and the true value B′ for B at positions different from the B pixel positions with use of four pieces of raw image data shot with mutually different lowpass characteristics of the lowpass filter 2. This makes it possible for the image processor 4 to calculate the true values for each of the three colors R, G, and B at all the pixel positions.

As with the case where the values for G are calculated in the above-described first embodiment, the following (Expression 4), (Expression 5), and (Expression 6) are established for the R pixel positions.

RL1_{xy}=α1R_{xy}+β1R′_{x-1y}+β1R′_{x+1y}+β1R′_{xy-1}+β1R′_{xy+1}+γ1R′_{x-1y-1}+γ1R′_{x-1y+1}+γ1R′_{x+1y-1}+γ1R′_{x+1y-1} (Expression 4)

RL2_{xy}=α2R_{xy}+β2R′_{x-1y}+β2R′_{x+1y}+β2R′_{xy-1}+β2R′_{xy+1}+γ2R′_{x-1y-1}+γ2R′_{x-1y+1}+γ2R′_{x+1y-1}+γ2R′_{x+1y-1} (Expression 5)

RL3_{xy}=α3R_{xy}+β3R′_{x-1y}+β3R′_{x+1y}+β3R′_{xy-1}+β3R′_{xy+1}+γ3R′_{x-1y-1}+γ3R′_{x-1y+1}+γ3R′_{x+1y-1}+γ3R′_{x+1y-1} (Expression 6)

Each of the (Expression 4), the (Expression 5), and the (Expression 6) is an expression for R at the R pixel positions in controlling the lowpass filter 2 to have a given degree of separation. Suffixes 1, 2, and 3 in the expressions indicate pixel values or coefficients upon each shooting. If the total number of pixels is X, the number of R pixels is X/4, and the number of unknown quantities is 3X/4. Therefore, an increase in the number of the expressions by increasing the number of shot images as described above ensures a balance between the number of unknown quantities and the number of expressions, allowing for solving as simultaneous equations.

In the above description, the R pixel is taken as an example; however, the same is true for the B pixel.

Any other configurations, operation, and effects may be substantially similar to those in the above-described first embodiment.

### 3. Other Embodiments

Although the technology achieved by present disclosure is not limited to description of the above-described respective embodiments, and may be modified in a variety of ways.

For example, in the above-described respective embodiments, the Bayer pattern is exemplified as a pixel structure; however, the pixel structure may be a pattern other than the Bayer pattern. For example, a pattern including a portion in which pixels of a same color are adjacent by consecutively disposing two or more pixels of any of R, G, and B may be adopted. For example, a structure including infrared (IR) pixels may be adopted, as illustrated in FIG. 14. Further, a structure including W (white) pixels may be adopted.

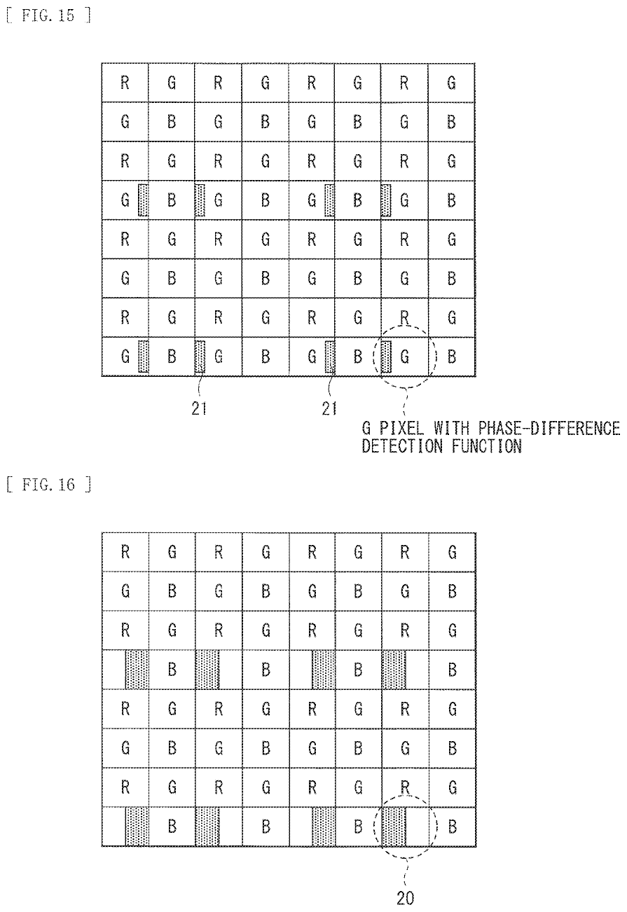

Alternatively, a structure including phase-difference pixels for phase-difference system AF (autofocus) may be adopted. In such a case, light-shielding films 21 may be provided on some of pixels as illustrated in FIG. 15, and such pixels may be used as pixels having a phase-difference detection function. For example, G pixels may be partially provided with the light-shielding films 21. Further, as illustrated in FIG. 16, a structure including phase-difference pixels 20 dedicated to phase-difference detection may be adopted.

It is also possible to infer true values at positions of the above-described phase-difference pixels or defective pixels in manufacturing of the imager 3 as unknown quantities, in a similar manner. In such a case, however, it is necessary to increase the number of the expressions because of an increase in the unknown quantities. Accordingly, it is necessary to increase the number of shot images. For example, in a case where some of the G pixels of the R, G, and B pixels are replaced with the phase difference pixels, the number of unknown G pixels becomes greater than X/2, but the number of unknown R and B pixels is 3X/4 without change, which makes it possible to obtain true values for R, G, and B at all the pixel positions by taking four images. In other words, in a case where a half or less of the G pixels are replaced with the phase-difference pixels, it is unnecessary to increase the number of images to be shot to more than four. Meanwhile, in a case where more than half of the G pixels are replaced, or the R and B pixels are missing, it is necessary to take four or more images. In a case where a configuration in which true values for R, G, and B at pixel positions other than R, G, and B, such as the phase-difference pixels or IR pixels are determined is adopted, it is possible to restore the true values at positions of the missing R, G, and B pixels. This allows pixels having a function other than R, G, and B to be disposed at higher density. The true values for R, G, and B at positions of the phase-difference pixels or the IR pixels are different from reproduction of defective pixels in that positions to be determined are known in advance.

Further, in the above-described respective embodiments, the pixel value includes color information; however, the pixel value may include only luminance information.

Furthermore, in the above-described respective embodiments, an image shot with the lowpass filter 2 turned off is surely used; however, only images shot with the lowpass filter 2 turned on with different degrees of separation may be used. For example, in the above-described first embodiment, one image shot with the lowpass filter 2 turned off, and one image shot with the lowpass Filter 2 turned on are used. However, it is only necessary to ensure a balance between the number of unknown quantities and the number of expressions. Therefore, it is possible to know all true values for G with use of two images shot with the lowpass filter 2 turned on with different degrees of separation, as with the above-described first embodiment.

Moreover, in the above-described respective embodiments, description is provided on an example of the variable optical lowpass filter 30 as the lowpass filter 2; however, a configuration in which the lowpass filter is turned on or off by mechanically taking the lowpass filter in and out may be adopted.

Further, in the above-described respective embodiments, synthesis processing of a plurality of images (the step S105 in FIG. 6) is carried out; however, it is also possible to avoid performing such synthesis processing on an as-needed basis. For example, in a case where a subject is moving, even if continuous shooting is performed, there is a low possibility that correct true values are calculated on the basis of a plurality of images. Therefore, the movement amount of two shot images is calculated from SAD (Sum of Absolute Difference), etc., and the synthesis processing may be avoided if the movement amount is equal to or higher than a certain level. Alternatively, in a case where the movement amount in a given region is equal to or higher than the certain level, the synthesis processing may be avoided only in the region. This makes it possible to take measures against the movement of the subject.

Moreover, various forms are conceivable as variations of a camera to which the imaging apparatus illustrated in FIG. 1 is applied. The lens unit 1 may be of a fixed type or an interchangeable type. It is also possible to omit the display 6 from the configuration. In a case where the lens unit 1 is of the interchangeable type, the lowpass filter 2 may be provided on a side on which the camera body is located, or may be provided on a side on which the lens unit 1 of the interchangeable type is located. In a case where the lowpass filter 2 is provided on the side on which the lens unit 1 of the interchangeable type is located, the lowpass filter controller 41 may be provided on the side on which the camera body is located, or may be provided on the side on which the lens unit 1 of the interchangeable type is located.

Further, the technology achieved by the present disclosure is also applicable to an in-vehicle camera, a surveillance camera, etc.

Furthermore, in the imaging apparatus illustrated in FIG. 1, a shooting result may be stored in the external memory 7, or the shooting result may be displayed on the display 6; however, image data may be transmitted to any other device through a network, in place of being stored or displayed. Moreover, the image processor 4 may be separated from a main body of the imaging apparatus. For example, the image processor 4 may be provided at an end of a network coupled to the imaging apparatus. Further, the main body of the imaging apparatus may store image data in the external memory 7 without performing image processing, and may cause a different device such as a PC (personal computer) to perform image processing.

It is to be noted that processing by the image processor 4 may be executed as a program by a computer. A program of the present disclosure is, for example, a program provided from, for example, a storage medium to an information processing device and a computer system that are allowed to execute various program codes. Executing such a program by the information processing device or a program execution unit in the computer system makes it possible to achieve processing corresponding to the program.

Moreover, a series of image processing by the present technology may be executed by hardware, software, or a combination thereof. In a case where processing by software is executed, it is possible to install a program holding a processing sequence in a memory in a computer that is built in dedicated hardware, and cause the computer to execute the program, or it is possible to install the program in a general-purpose computer that is allowed to execute various kinds of processing, and cause the general-purpose computer to execute the program. For example, it is possible to store the program in the storage medium in advance. In addition to installing the program from the storage medium to the computer, it is possible to receive the program through a network such as LAN (Local Area Network) and the Internet and install the program in a storage medium such as a built-in hard disk.

Further, the present technology may have the following configurations, for example.

(1)

An image processing device, including:

an image processor that generates image data on the basis of a plurality of pieces of raw image data shot with mutually different lowpass characteristics of an optical lowpass filter, the image data that is higher in resolution than each of the plurality of pieces of raw image data.

(2)

The image processing device according to (1), in which the optical lowpass filter is a variable optical lowpass filter that is allowed to change a degree of separation of light for incoming light.

(3)

The image processing device according to (2), in which the optical lowpass filter is a liquid crystal optical lowpass filter.

(4)

The image processing device according to (2) or (3), in which the plurality of pieces of raw image data include raw image data shot with the degree of separation set to zero.

(5)

The image processing device according to any one of (1) to (4), in which

each of the plurality of pieces of raw image data includes data of pixels of a plurality of colors located at pixel positions different for each color, and

the image processor calculates a pixel value for at least one predetermined color of the plurality of colors at a position different from a position of a pixel of the predetermined color.

(6)

The image processing device according to any one of (1) to (5), in which the plurality of pieces of raw image data include two pieces of raw image data.

(7)

The image processing device according to (6), in which

each of the two pieces of raw image data includes data of pixels of three colors, and

the image processor calculates a pixel value for one predetermined color of the three colors at a position different from a position of a pixel of the predetermined color.

(8)

The image processing device according to (7), in which the three colors are red, green, and blue, and the predetermined color is green.

(9)

The image processing device according to any one of (1) to (4), in which

the plurality of pieces of raw image data include four pieces of raw image data,

each of the four pieces of raw image data includes data of pixels of a first color, a second color, and a third color, and

the image processor calculates a pixel value for the first color at a position different from a position of the pixel of the first color, a pixel value for the second color at a position different from a position of the pixel of the second color, and a pixel value for the third color at a position different from a position of the pixel of the third color.

(10)

An image processing method, including:

generating image data on the basis of a plurality of pieces of raw image data shot with mutually different lowpass characteristics of an optical lowpass filter, the image data that is higher in resolution than each of the plurality of pieces of raw image data.

(11)

An imaging apparatus, including:

an image sensor;

an optical lowpass filter disposed on a light entrance side with respect to the image sensor; and

an image processor that generates image data on the basis of a plurality of pieces of raw image data shot with mutually different lowpass characteristics of the optical lowpass filter, the image data that is higher resolution than each of the plurality of pieces of raw image data.

(12)

A program causing a computer to serve as an image processor that generates image data on the basis of a plurality of pieces of raw image data shot with mutually different lowpass characteristics of an optical lowpass filter, the image data that is higher in resolution than each of the plurality of pieces of raw image data.

This application claims the benefit of Japanese Priority Patent Application No. 2016-045504 filed with the Japan Patent Office on Mar. 9, 2016, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An image processing device, comprising:
an image processor that generates image data on a basis of a plurality of pieces of raw image data shot with mutually different lowpass characteristics of an optical lowpass filter, the image data that is higher in resolution than each of the plurality of pieces of raw image data.

2. The image processing device according to claim 1, wherein the optical lowpass filter is a variable optical lowpass filter that is allowed to change a degree of separation of light for incoming light.

3. The image processing device according to claim 2, wherein the optical lowpass filter is a liquid crystal optical lowpass filter.

4. The image processing device according to claim 2, wherein the plurality of pieces of raw image data include raw image data shot with the degree of separation set to zero.

5. The image processing device according to claim 1, wherein
each of the plurality of pieces of raw image data includes data of pixels of a plurality of colors located at pixel positions different for each color, and
the image processor calculates a pixel value for at least one predetermined color of the plurality of colors at a position different from a position of a pixel of the predetermined color.

6. The image processing device according to claim 1, wherein the plurality of pieces of raw image data include two pieces of raw image data.

7. The image processing device according to claim 6, wherein
each of the two pieces of raw image data includes data of pixels of three colors, and
the image processor calculates a pixel value for one predetermined color of the three colors at a position different from a position of a pixel of the predetermined color.

8. The image processing device according to claim 7, wherein the three colors are red, green, and blue, and the predetermined color is green.

9. The image processing device according to claim 1, wherein
the plurality of pieces of raw image data include four pieces of raw image data,
each of the four pieces of raw image data includes data of pixels of a first color, a second color, and a third color, and
the image processor calculates a pixel value for the first color at a position different from a position of the pixel of the first color, a pixel value for the second color at a position different from a position of the pixel of the second color, and a pixel value for the third color at a position different from a position of the pixel of the third color.

10. An image processing method, comprising:
generating image data on a basis of a plurality of pieces of raw image data shot with mutually different lowpass characteristics of an optical lowpass filter, the image data that is higher in resolution than each of the plurality of pieces of raw image data.

11. An imaging apparatus, comprising:
an image sensor;
an optical lowpass filter disposed on a light entrance side with respect to the image sensor; and
an image processor that generates image data on a basis of a plurality of pieces of raw image data shot with mutually different lowpass characteristics of the optical lowpass filter, the image data that is higher in resolution than each of the plurality of pieces of raw image data.

12. A program causing a computer to serve as an image processor that generates image data on a basis of a plurality of pieces of raw image data shot with mutually different lowpass characteristics of an optical lowpass filter, the image data that is higher in resolution than each of the plurality of pieces of raw image data.
